(19) United States
(12) Patent Application Publication
(10) Pub. No.: US 2002/0017865 A1
(43) Pub. Date: Feb. 14, 2002

(54) Gas discharge tube

(75) Inventor: Tomoyuki Ikedo, Hamamatsu-shi (JP)

Correspondence Address: MORGAN, LEWIS & BOCKIUS, 1800 M STREET NW, WASHINGTON, DC, 20036-5869, US

(73) Assignee: HAMAMATSU PHOTONICS K.K.

(21) Appl. No.: 09/875,925

(22) Filed: Jun. 8, 2001

Related U.S. Application Data
(63) Continuation-in-part of application No. PCT/JP99/06916, filed on Dec. 9, 1999.

(30) Foreign Application Priority Data
Dec. 9, 1998 (JP) P1998-350445

(51) Int. Cl. H01J 17/04; H01J 61/04

(52) U.S. Cl. 313/631; 313/310; 313/294; 313/452

(57) ABSTRACT

Since an internal surface of an arc ball receiving recess, which greatly affects the shape of an arc ball, is formed in an arcuate cross section swelling outward, the arc ball can be formed so as to be received in the arc ball receiving recess in front of a focusing opening of a slit shape, whereby the arc ball can be formed in a well-regulated form. Therefore, the arc ball with uniform luminance distribution in the longitudinal direction of the slit focusing opening can be made with certainty in the arc ball receiving recess.

### RELATED APPLICATIONS

This is a Continuation-In-Part application of International Patent application serial No. PCT/JP99/06916 filed on Dec. 9, 1999, now pending.

### BACKGROUND OF THE INVENTION

1. Field of the Invention

The present invention relates to a gas discharge tube and, more particularly, to a gas discharge tube used as an ultraviolet light source or the like for spectrophotometer, liquid chromatography, and so on.

2. Related Background Art

The conventional technology in this field includes the technique disclosed in Japanese Patent Application Laid-Open No. H04-147557. In a deuterium discharge tube described in this application, a focusing opening as a small hole of slit shape is formed in a focusing electrode plate interposed between anode and cathode. This focusing opening is formed in such a strip shape as to match with a slit shape of an analyzer, thereby increasing utilization efficiency of light emitted from the discharge tube. As illustrated in FIG. 30, the focusing electrode plate 102 has an arc ball receiving recess 100 of a constricted shape curved inside and ultraviolet light is emitted along a direction of an arrow 103 from an arc ball 101 made by the recess.

### SUMMARY OF THE INVENTION

However, the shape of the arc ball 101 made by the arc ball receiving recess 100 is dependent upon the shape of an internal wall surface 100a of the arc ball receiving recess 100. Therefore, in the aforementioned conventional gas discharge tube, the arc ball 101 is formed so as to swell out from the arc ball receiving recess 100 and is inevitably deformed from a regular ball shape. As a result, it posed the problem that it was difficult to obtain a steady high-luminance emission.

The present invention has been accomplished in order to solve the above problem and a specific object of the invention is to provide a gas discharge tube capable of supplying a steady high-luminance emission.

In order to achieve the above object, a gas discharge tube according to the present invention is a gas discharge tube comprising a hot cathode for generating thermoelectrons, an anode for receiving the thermoelectrons, and a focusing electrode provided between the hot cathode and the anode, for converging the thermoelectrons, wherein the converging electrode comprises an arc ball receiving recess projecting toward the anode, an internal surface of the arc ball receiving recess is formed in an arcuate cross section swelling outward, and a focusing opening of a slit shape located in front of the anode is provided in a bottom portion of the arc ball receiving recess.

Since in this gas discharge tube the internal surface of the arc ball receiving recess, which largely affects the shape of the arc ball, is formed in the arcuate cross section swelling outward, it becomes feasible to form the arc ball so as to be received in the arc ball receiving recess in front of the focusing opening of the slit shape, whereby the arc ball can be formed in a well-regulated shape. Accordingly, it becomes feasible to make the arc ball with uniform luminance distribution in the longitudinal direction of the slit focusing opening, with certainty in the arc ball receiving recess.

It is preferable to form the slit focusing opening in a flat portion provided in the bottom portion of the arc ball receiving recess. In this case, on the occasion of making the slit focusing opening in the arc ball receiving recess, the flat portion provided in the arc ball receiving recess ensures the formation of the focusing opening in even width. In addition, the flat portion also ensures generation of the arc ball extending along the flat portion in front of the focusing opening.

Another gas discharge tube according to the present invention is a gas discharge tube comprising a hot cathode for generating thermoelectrons, an anode for receiving the thermoelectrons, and a focusing electrode provided between the hot cathode and the anode, for converging the thermoelectrons, wherein the focusing electrode comprises an arc ball receiving recess projecting toward the anode, an internal surface of the arc ball receiving recess is formed in a substantially triangular cross section, and a focusing opening of a slit shape located in front of the anode is provided in a bottom portion of the arc ball receiving recess.

Since in this gas discharge tube the internal surface of the arc ball receiving recess, which largely affects the shape of the arc ball, is formed in the triangular cross section, it becomes feasible to form the arc ball so as to be received in the arc ball receiving recess in front of the focusing opening of the slit shape, whereby the arc ball can be formed in a well-regulated shape. Accordingly, the arc ball with uniform luminance distribution in the longitudinal direction of the slit focusing opening can be made with certainty in the arc ball receiving recess.

Another gas discharge tube according to the present invention is a gas discharge tube comprising a hot cathode for generating thermoelectrons, an anode for receiving the thermoelectrons, and a focusing electrode provided between the hot cathode and the anode, for converging the thermoelectrons, wherein the focusing electrode comprises an arc ball receiving recess projecting toward the anode, an internal surface of the arc ball receiving recess is formed in a substantially trapezoid cross section, a flat portion is provided in a bottom portion of the arc ball receiving section, and a focusing opening of a slit shape located in front of the anode is provided in the flat portion.

Since in this gas discharge tube the internal surface of the arc ball receiving recess, which largely affects the shape of the arc ball, is formed in the trapezoid cross section, it becomes feasible to form the arc ball so as to be received in the arc ball receiving recess in front of the focusing opening of the slit shape, whereby the arc ball can be formed in a well-regulated shape. Accordingly, the arc ball with uniform luminance distribution in the longitudinal direction of the slit focusing opening can be made with certainty in the arc ball receiving recess. In addition, on the occasion of forming the slit focusing opening in the arc ball receiving recess, the flat portion provided in the arc ball receiving recess ensures the formation of the focusing opening in even width. The position of the focusing opening can be always kept constant in the longitudinal direction of the focusing opening and this ensures the generation of the arc ball extending along the flat portion.

It is preferable that B/A be in a range of 0.1 to 0.5, where A is an opening length in a longitudinal direction of the focusing opening and B an opening length thereof in a direction perpendicular to the longitudinal direction, and that an opening area of the focusing opening be in a range of 0.15 to 0.5 mm².

In the case of the commonly known focusing openings, the limit is normally a circular hole having the diameter of 0.5 mm because of increase in discharge starting voltage or occurrence of abnormal discharge. This is because decrease of the diameter of the focusing opening to below 0.5 mm will result in increasing the barrier between the hot cathode and the anode and thus necessitating high energy for a start of discharge. With increase in this energy (for example, with increase in discharge voltage), there will occur an event of failure in lighting of the gas discharge tube because of the abnormal discharge. In order to ensure a stable discharge start, the inventor noted the area of the focusing opening of the slit shape. It was then verified by experiments that increase in the area of the focusing opening surely made it easier to induce arc discharge between the hot cathode and the anode but the luminance of emission became lower. For ensuring high luminance while enabling lighting of the gas discharge tube, the opening area was thus narrowed down into the range of 0.15 to 0.5 mm². In addition, while taking the aforementioned opening area into consideration, the inventor also noted the relation between the opening length A in the longitudinal direction of the focusing opening and the opening length B in the direction perpendicular to the longitudinal direction, in order to obtain the uniform emission with high luminance. Then the shape of the focusing opening was specified using the equation of relation of B/A and the value thereof was narrowed into the range of 0.1 to 0.5. The inventor succeeded in specifying the uniform slit light with a good lighting property and with high luminance in the gas discharge tube, by limiting the focusing opening by the various parameters as described above, which will provide an aid for use of the emission.

The focusing opening is preferably formed so that B/A is in a range of 0.1 to 0.25 and the opening area is in a range of0.15 to 0.25 mm². This permits the discharge tube to supply light with uniform luminance distribution and with extremely high luminance, thereby enhancing the intensity of the spot emission so as to meet market needs.

The present invention will become more fully understood from the detailed description and the accompanying drawings which follow. These are to be considered in all respects as illustrative and not restrictive to the present invention.

The scope of further application of the present invention will become apparent from the detailed description of the invention which follows. However, the detailed description and specific examples are presented only for the purpose of illustration while demonstrating preferred embodiments of the present invention, and it is clear that various modifications and improvements within the spirit and scope of the invention are obvious to those skilled in the art from the detailed description.

### BRIEF DESCRIPTION OF THE DRAWINGS

FIG. 1 is a perspective view to show an embodiment of the gas discharge tube according to the present invention.

FIG. 2 is an exploded perspective view of a light-emitting section in the gas discharge tube of FIG. 1.

FIG. 3 is a perspective view to show a state before assembly of a support member and an anode plate in the light-emitting section of FIG. 2.

FIG. 4 is a perspective view to show a state before assembly of a discharge shielding member and the anode plate in the light-emitting section of FIG. 2.

FIG. 5 is a plan view to show the positional relation among the discharge shielding member, the anode plate, and the support member in the light-emitting section of FIG. 2.

FIG. 6 is a cross-sectional view along a line VI-VI of FIG. 5.

FIG. 7 is a cross-sectional view along a line VII-VII of FIG. 5.

FIG. 8 is a perspective view to show a first example of an opening limiter applied to the gas discharge tube of the present invention.

FIG. 9 is a cross-sectional view along a line IV-IV of FIG. 8.

FIG. 10 is a cross-sectional view along a line X-X of FIG. 8.

FIG. 11 is a schematic diagram to show a focusing opening.

FIG. 12 is a graph to show the relationship between opening area and aspect ratio of aperture in the focusing opening.

FIG. 13 is a schematic diagram to show another example of the focusing opening.

FIG. 14 is a perspective view to show a second example of the opening limiter applied to the gas discharge tube of the present invention.

FIG. 15 is a plan view of the opening limiter illustrated in FIG. 14.

FIG. 16 is a cross-sectional view along a line XVI-XVI of FIG. 15.

FIG. 17 is a cross-sectional view along a line XVII-XVII of FIG. 15.

FIG. 18 is a perspective view to show a third example of the opening limiter applied to the gas discharge tube of the present invention.

FIG. 19 is a plan view of the opening limiter illustrated in FIG. 18.

FIG. 20 is a cross-sectional view along a line XX-XX of FIG. 19.

FIG. 21 is a cross-sectional view along a line XXI-XXI of FIG. 19.

FIG. 22 is a perspective view to show a fourth example of the opening limiter applied to the gas discharge tube of the present invention.

FIG. 23 is a plan view of the opening limiter illustrated in FIG. 22.

FIG. 24 is a cross-sectional view along a line XXIV-XXIV of FIG. 23.

FIG. 25 is a cross-sectional view along a line XXV-XXV of FIG. 23.

FIG. 26 is a perspective view to show a fifth example of the opening limiter applied to the gas discharge tube of the present invention.

FIG. 27 is a plan view of the opening limiter illustrated in FIG. 26.

FIG. 28 is a cross-sectional view along a line XXVIII-XXVIII of FIG. 27.

FIG. 29 is a cross-sectional view along a line XXIV-XXIV of FIG. 27.

FIG. 30 is a cross-sectional view to show the shape of the arc ball receiving recess applied to the conventional gas discharge tube.

### DESCTIPRION OF THE PREFERRED EMBODIMENTS

The preferred embodiments of the gas discharge tube according to the present invention will be described hereinafter in detail with reference to the accompanying drawings.

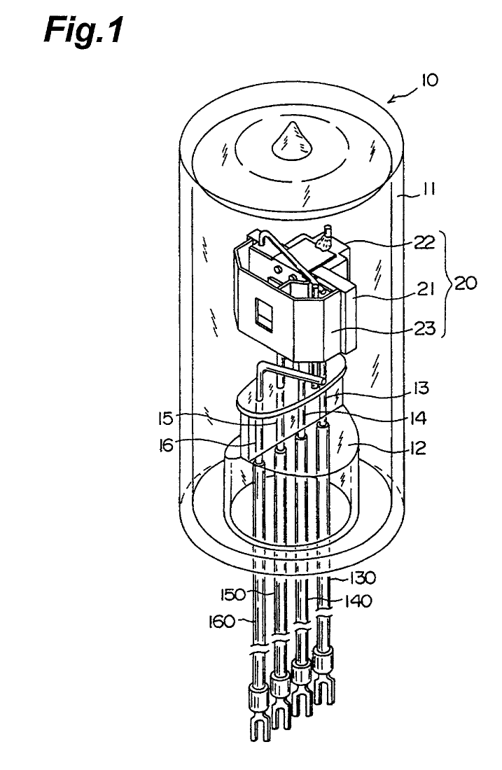

FIG. 1 shows a side-on type deuterium lamp as an example of the gas discharge tube. In this gas discharge tube 10, a light-emitting section 20 is housed inside an envelope 11 of glass and deuterium gas (not illustrated) is confined under the pressure of about several Torr. The envelope 11 is formed in a cylindrical shape with its head portion being sealed and the bottom portion of the envelope 11 is hermetically sealed by a glass stem 12. The envelope 11 is made of ultraviolet-transmitting glass or silica glass having a high UV transmittance.

Four lead pins 13 to 16 juxtaposed on a straight line extend from the bottom portion of the light-emitting section 20 and penetrate the stem 12. These lead pins 13 to 16 are covered by insulating members 130, 140, 150, 160, respectively, and connected to a predetermined lighting circuit. The light-emitting section 20 is constructed in a shielding box structure in which a ceramic support member 22 and a metal front window electrode 23 are bonded to each other with a discharge shielding member (spacer) 21 in between.

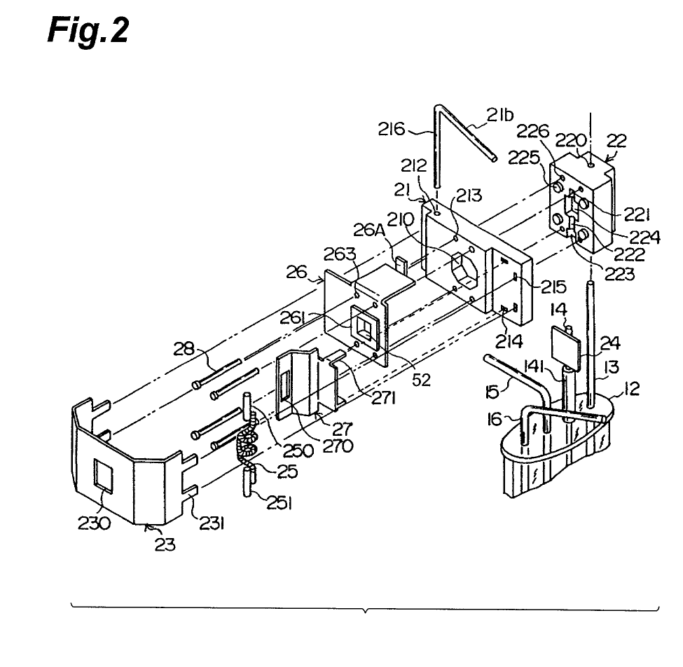

The structure of the light-emitting section 20 will be described below in detail with reference to FIGS. 2 to 7.

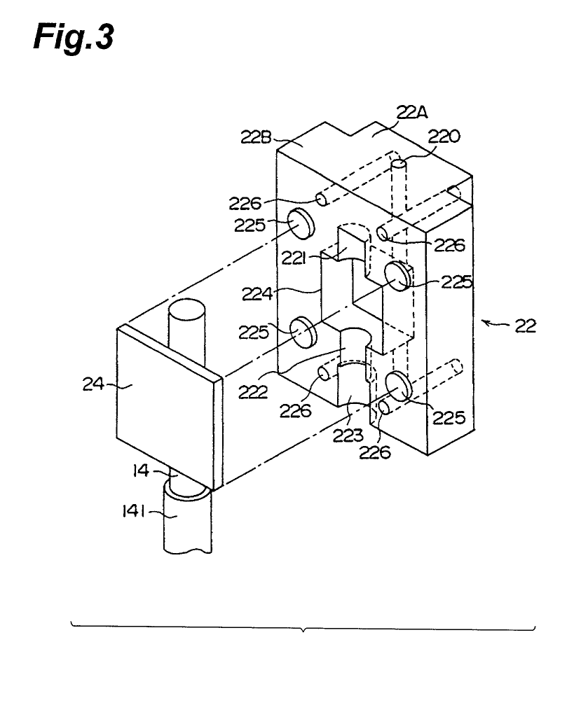

As shown in FIG. 2 and FIG. 3, the support member 22 of a prism of a [symbol] -shaped cross section is provided with a vertical through hole 220, concave grooves 221 to 223, a depression 224, four projections 225, and four horizontal through holes 226. The vertical through hole 220 vertically extends through a projected portion 22A in the rear part of the support member 22 of the [symbol] -shaped section. The concave groove 221, depression 224, and concave grooves 222, 223 are depressed from the surface of a front flat portion 22B and extend in succession toward the bottom portion of the envelope 11. This allows the lead pin 14 and insulating member 141 to be appropriately accommodated. The four projections 225 project from the surface of the flat portion 22B two each in the vicinity of opening edges of the concave grooves 221, 222 so as to be opposed to the respective corners of an anode plate 24. The four horizontal through holes 226 horizontally extend to penetrate the support at two positions each in the upper end portion and in the lower end portion.

This support member 22 is held by the stem 12 through the lead pin 13 penetrating the vertical through hole 220 and through the lead pin 14 fitted in the concave grooves 221 to 223. The anode plate 24 formed in a rectangular flat plate shape is welded and fixed to the distal end of the lead pin 14 and supported from the back by the four projections 225. A heat-radiating space is ensured behind the anode 24 by the depression 224 having an aperture substantially equivalent to the surface area of the anode 24.

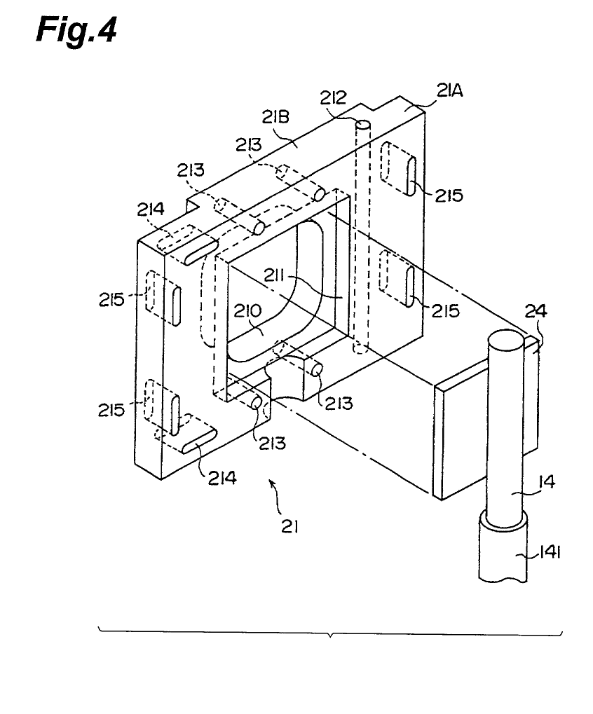

As shown in FIG. 2 and FIG. 4, the discharge shielding member 21 formed in a flat plate shape is of a [symbol] -shaped cross section thinner and wider than the support member 22 and is provided with a through hole 210, a recess 211, a vertical through hole 212, four horizontal through holes 213, two horizontal through holes 214, and four horizontal through holes 215. The through hole 210 penetrates almost the center of the discharge shielding member 21 so as to be opposed to the anode 24. The recess 211 is depressed from the surface of a flat portion 21A in the back of the discharge shielding member 21 in order to accommodate the anode 24, and includes a first opening edge of the through hole 210 located on the back side. The vertical through hole 212 penetrates a projected portion 21B on the front side. The four horizontal through holes 213 horizontally extend to be opposed to the four horizontal through holes 226 of the support member 22. The two horizontal through holes 214 of the discharge shielding member 21 are formed at positions to accept lock pawls 271 of a cathode slit electrode 27 described hereinafter, and the four horizontal through holes 215 at positions to accept lock pawls 231 of the front window electrode 23 described hereinafter.

A bent portion of a substantially L-shaped electrode rod 216 is fitted in the vertical through hole 212 and the lower end thereof is exposed from the discharge shielding member 21. The lower end of the electrode rod 216 is welded and fixed to the distal end of the lead pin 15. Thus the discharge shielding member 21 is held by the stem 12 through the electrode rod 216. Electrode rods 250, 251 are welded to the two ends of a hot cathode (filament) 25, respectively. Then the distal end of the electrode rod 250 is welded to the electrode rod 216, and the distal end of the electrode rod 251 to the distal end of the lead pin 16. In this structure, the hot cathode 25 is held by the stem 12.

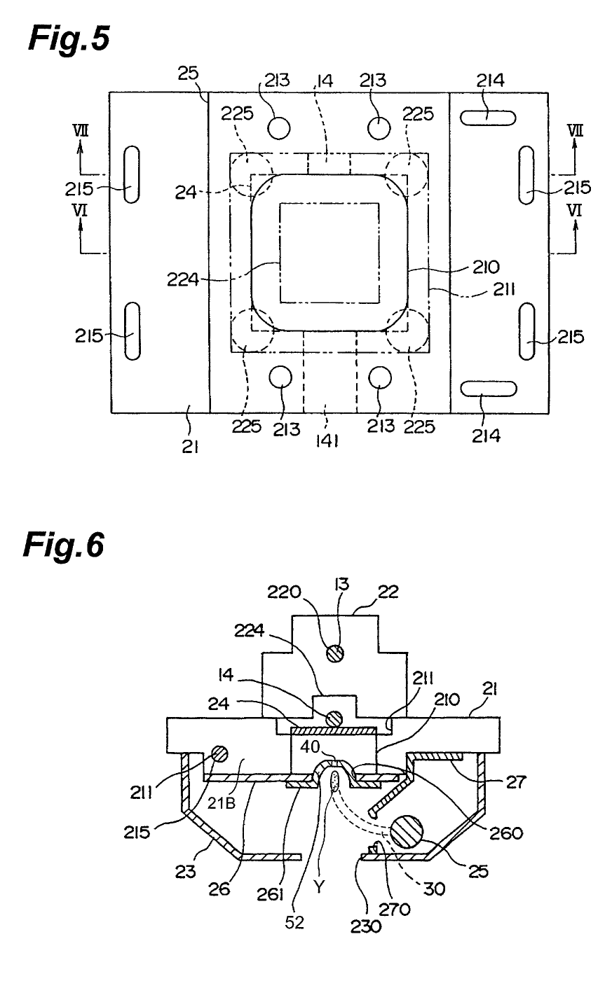

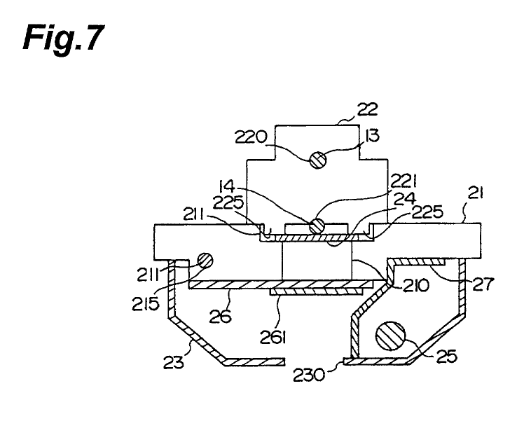

As shown in FIGS. 5 to 7, the rectangular anode 24 indicated by the dashed line is received in the recess 211 of the discharge shielding member 21 and the corner portions of the anode 24 are sandwiched by cooperation of the bottom surface of the recess 211 of the discharge shielding member 21 and the four projections 225 of the support member 22. Most of the four sides of the anode 24 match the through hole 210 of the substantially rectangular shape slightly rounded, and the other portions of the first opening edge are joined to the four corner portions of the anode 24. The four projections 225 with the circular surface are joined to the four corner portions of the anode 24 so as to press the anode 24. In particular, as illustrated in FIG. 7, the rectangular recess 211 has a depth equal to the sum of the height of the four projections 225 and the thickness of the anode 24, so that the peripheral region in the front surface of the support member 22 can abut on the back surface of the discharge shielding member 21.

As shown in FIG. 2 and FIG. 6, a focusing electrode 26 is formed by bending a metal plate into a substantially L-shape, and is provided with an opening 260 and four horizontal through holes 263. This opening 260 is arranged coaxial with the through hole 210 of the discharge shielding member 21. An opening limiter 261 for limiting the opening diameter is welded to the peripheral area of the opening 260. The opening limiter 261 is provided with an arc ball receiving recess 262 projecting toward the anode 24 so as to pass the opening 260 and a focusing opening 40 of a slit shape is formed in the center of the recess 262. The four horizontal through holes 263 are formed through the thickness of the focusing electrode 26 so as to be opposed to the four horizontal through holes 213 of the discharge shielding member 21.

This focusing electrode 26 is set in contact on the projected part 21B of the discharge shielding member 21 and a distal end 26A bent backward is welded to the distal end of the lead pin 13 projecting from the support member 22. In this way the focusing electrode 26 is fixed to the discharge shielding member 21 and to the support member 22. It is noted here that the distance between the opening limiter 261 and the anode 24 is smaller than the thickness of the discharge shielding member 21. Here the horizontal through holes 226, 213, 263 of the discharge shielding member 21, the support member 22, and the focusing electrode 26 are aligned in line in each set. Therefore, these members can be fixed together to the stem 12 by inserting four metal rivets 28 into the through holes in a bonded state of the discharge shielding member 21, the support member 22, and the focusing electrode 26.

As illustrated in FIGS. 2, 6, and 7, the metal cathode slit electrode 27 is bent corresponding to the shape of the stepped region of the discharge shielding member 21 and has an opening 270 and two lock pawls 271. The opening 270 formed in a vertically long rectangular shape is made in the front part of the cathode slit electrode 27. The two lock pawls 271 formed at the upper and lower ends of the cathode slit electrode 27 are bent backward.

This cathode slit electrode 27 faces the hot cathode 25 and is placed on the front surface on one side of the discharge shielding member 21. The cathode slit electrode 27 is fixed to the discharge shielding member 21 by inserting the two lock pawls 271 into the two horizontal through holes 214 of the discharge shielding member 21. The opening 270 is located between the hot cathode 25 and the opening limiter 261.

The front window electrode 23 of metal is formed in a substantially U-shaped cross section bent at four positions and is also provided with an opening window 230 and four lock pawls 231. The opening window 230 formed in a rectangular shape is arranged coaxial with the arc ball receiving recess 262 of the focusing electrode 26. The four lock pawls 231 formed in the upper and lower parts on the both side ends of the front window electrode 23 project backward. The opening window 230 is located at the position to project ultraviolet light from the space in front of the arc ball receiving recess 262.

This front window electrode 23 is fixed to the discharge shielding member 21 by inserting the four lock pawls 231 into the four horizontal through holes 215 of the discharge shielding member 21. Then the front end of the cathode slit electrode 27 is brought into contact with the internal surface of the front window electrode 23, whereby the space for placement of the hot cathode 25 can be separated from the emission space for occurrence of arc discharge.

With the focusing electrode 26, cathode slit electrode 27, and front window electrode 23 constructed in this structure, the focusing electrode 26 is electrically insulated through the discharge shielding member 21 from the cathode slit electrode 27 and the front window electrode 23. On the other hand, the cathode slit electrode 27 and the front window electrode 23 are in contact with each other and set at a common potential.

The operation of the gas discharge tube 10 described above will be briefly described below.

First, an unrepresented trigger switch is set in an off state and a luminance control switch is set in an on state with respect to a discharge starting circuit. This results in applying the voltage of about 2.5 V from a cathode-heating voltage supply to the hot cathode 25 for about 20 seconds before discharge, to preheat the hot cathode 25. After the hot cathode 25 is heated well up to the temperature of about 1100° C., the voltage of about 150 V is applied from a field-generating voltage supply to between the hot cathode 25 and the anode 24, thereby generating an electric field directed from the anode 24 to the hot cathode 25.

After completion of preparation for trigger discharge in this manner, the trigger switch is turned on to bring the focusing electrode 26 into the potential of about 150 V, thereby inducing trigger discharge between the hot cathode 25 and the focusing electrode 26.

Since the focusing electrode 26 is electrically insulated from the cathode slit electrode 27 and the front window electrode 23, the focusing electrode 26 can be set at a positive potential higher than the cathode slit electrode 27 and the front window electrode 23 set at the potential of approximately 0 V. For this reason, as illustrated in FIG. 6, a trigger discharge area 30 is generated so as to extend from the hot cathode 25, and thus the trigger discharge area 30 extends from the space surrounded by the front window electrode 23 and the cathode slit electrode 27, i.e., from the inside of the cathode box up to the focusing electrode 26. The trigger discharge is induced between the hot cathode 25 and the opening limiter 261 in this way, so that an oblate arc ball Y is generated in the arc ball receiving recess 262. UV light from this arc ball (i.e., positive column light) Y travels through the opening window 230 of the front window electrode 23 to emerge in the form of slit light.

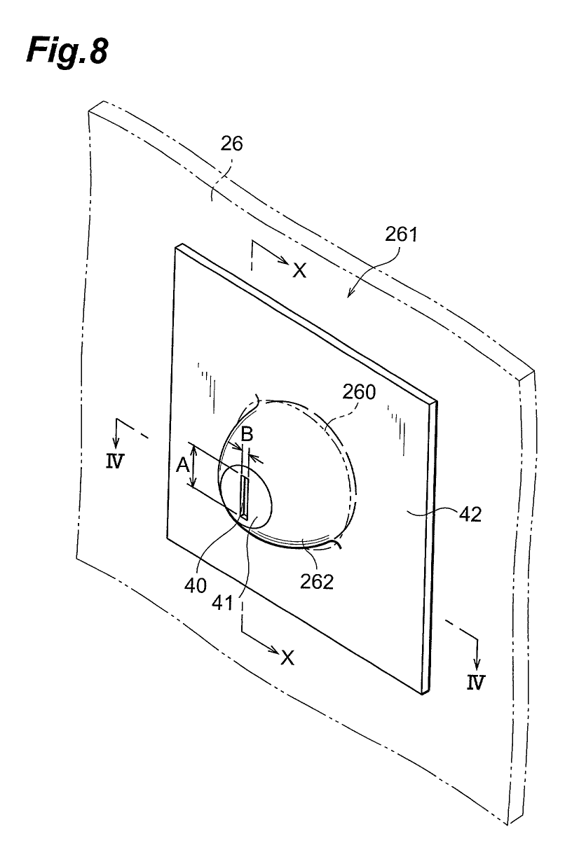

As shown in FIG. 8 to FIG. 10, the opening limiter 261 disposed on the focusing electrode 26 has a rectangular flat substrate 42 of molybdenum, which is a refractory metal. The arc ball receiving recess 262 of a cup shape is made by press work of the substrate 42 and is provided in the center of the opening limiter 261. The arc ball receiving recess 262 is formed in a substantially semispherical shape in which an internal surface 262a thereof is formed in an arcuate cross section swelling outward. Specifically, the radius R1 of the internal surface 262a of the arc ball receiving recess 262 is approximately 2 mm. An aperture 262b of the arc ball receiving recess 262 is circular and the aperture diameter D thereof is approximately 4 mm. A circular flat portion 41 having the radius of about 1 mm is formed in the bottom portion of the arc ball receiving recess 262. A focusing opening 40 of a slit shape is formed in the center of the flat portion 41. In the opening limiter 261 used in this embodiment, the size of the substrate 42 is 8×8 mm and the thickness thereof is in the range of approximately 0.3 to 0.7 mm. However, the material of the substrate can be another refractory metal such as tungsten or the like. Then an oblate arc ball Y is generated so as to be received in such an arc ball receiving recess 262 (see the chain line). This oblate arc ball Y mostly develops with uniform and high luminance in front of the focusing opening 40 and emits light in a slit form.

For the commonly known focusing openings 40, the limit was normally a circular hole having the diameter of 0.5 mm because of the increase of discharge start voltage or the occurrence of abnormal discharge. This is because decrease in the diameter of the focusing opening 40 to below 0.5 mm will increase the barrier between the hot cathode 25 and the anode 24 and raise the need for high energy upon a start of discharge. With increase in this energy (for example, with increase in the discharge voltage), there will occur an event of failure in lighting of the gas discharge tube 10 due to abnormal discharge.

In order to ensure a stable discharge start, the inventor thus noted the area S of the focusing opening 40. The inventor verified by experiments that increase in the area S of the focusing opening 40 surely made it easier to induce arc discharge between the hot cathode 25 and the anode 24 but the luminance of emission decreased so as to become dim as a whole. Thus the opening area S was narrowed into the range of0.15 to 0.5 mm² in order to ensure high luminance while enabling lighting of the gas discharge tube 10 by the rectangular focusing opening 40. It was verified by experiments that steady lighting of the gas discharge tube 10 was difficult when the opening area S was less than 0.15 mm² and that the light became too spread and it was difficult to utilize the light as a spotlike beam when the opening area S exceeded 0.5 mm².

Further, in order to obtain a uniform slit emission with high luminance and with a clear outline, while taking the aforementioned opening area S into consideration, the inventor noted the relation between the opening length A in the longitudinal direction of the focusing opening 40 and the opening length B thereof in the direction perpendicular to the longitudinal direction, as shown in FIG. 11. Then the inventor attempted to specify the shape of the focusing opening 40 by use of an equation defining the relation of B/A (aspect ratio). As a result, the inventor confirmed by experiments that with the emission made by the rectangular focusing opening 40, the light could be utilized as a spotlike beam when the value of B/A was set in the range of 0.1 to 0.5, in order to ensure uniform light with high luminance and with a clear outline.

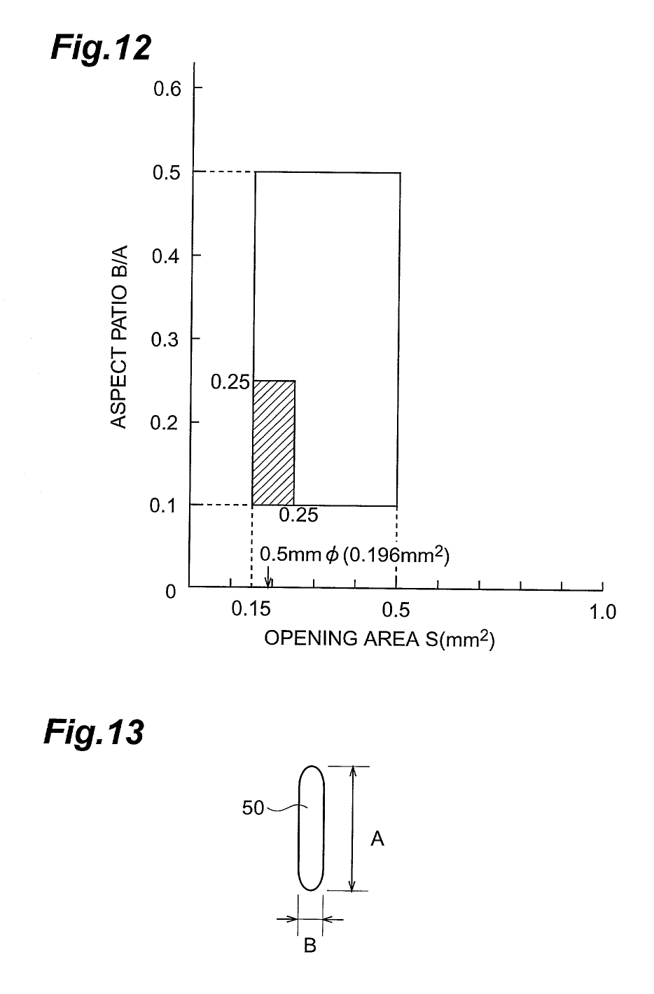

In particular, it is preferable that the value of B/A be in the range of 0.1 to 0.25 and that the opening area S be in the range of 0.15 to 0.25 mm² In this case, the light can be obtained with uniform luminance distribution and with extremely high luminance, thereby succeeding in providing the strong spot of slit emission so as to meet the market needs. These relations are presented in FIG. 12.

An example satisfying the relations is the focusing opening 40 of the slit shape having the opening length B of0.15 mm and the opening length A of 1 mm. In this case, when light output was actually measured with a spectrophotometer, the discharge tube emitted the output approximately three times higher than the conventional discharge tube with the circular hole having the diameter of 0.5 mm. This is extremely slender and strong light output, which was not attained before. For making the slender slit light, where the value of B is not more than 0.5 mm, other examples of the focusing opening 40 are, for example, a shape in which A is 1.0 mm and B 0.2 mm, and so on. The graph illustrated in FIG. 12 can also be applied to a configuration in which the opening limiter 261 is formed using a focusing opening 50 of an elongated elliptic shape, as illustrated in FIG. 13.

The slit light emitted from such a gas discharge tube 10 is used as a light source in the spectrophotometers, and the analyzers for liquid chromatography, capillary electrophoresis, and so on. In recent years, spotlike light is used as a light source for analysis in order to prevent influence from optics, stray light, and so on, but there is the desire for stronger and smaller spot light with decrease in the size of cells of the analyzers. Thus the gas discharge tube 10 described in the aforementioned embodiment fully satisfies this desire.

As described above, in the aforementioned gas discharge tube 10 the shape of the focusing opening 40 is the slit shape. The reason is as follows: since the hot cathode 25 has the vertically long structure extending in the vertical direction, the focusing opening 40 also needs to be formed in the shape vertically long and narrow shape extending along the hot cathode 25 in order to form the arc ball Y with uniform luminance distribution while reducing dispersion of distribution density of thermoelectrons emitted from the hot cathode 25. In addition, in the aforementioned gas discharge tube 10, the internal surface 262a of the arc ball receiving recess 262, which greatly affects the shape of the arc ball Y, is formed in the arcuate cross section swelling outward. This is for the purpose of forming the arc ball Y so as to be received in the arc ball receiving recess 262 in front of the focusing opening 40 and in the well-regulated shape. In the aforementioned gas discharge tube 10, as described, the combination of the slit focusing opening 40 with the arc ball receiving recess 262 of the arcuate cross section permits the arc ball Y with uniform luminance distribution in the longitudinal direction of the focusing opening 40 to be made with certainty in the arc ball receiving recess 262, thereby making it feasible to obtain a steady emission with high luminance.

The gas discharge tube of the present invention is not limited to the above embodiment. Various modifications of the arc ball receiving recess will be described below.

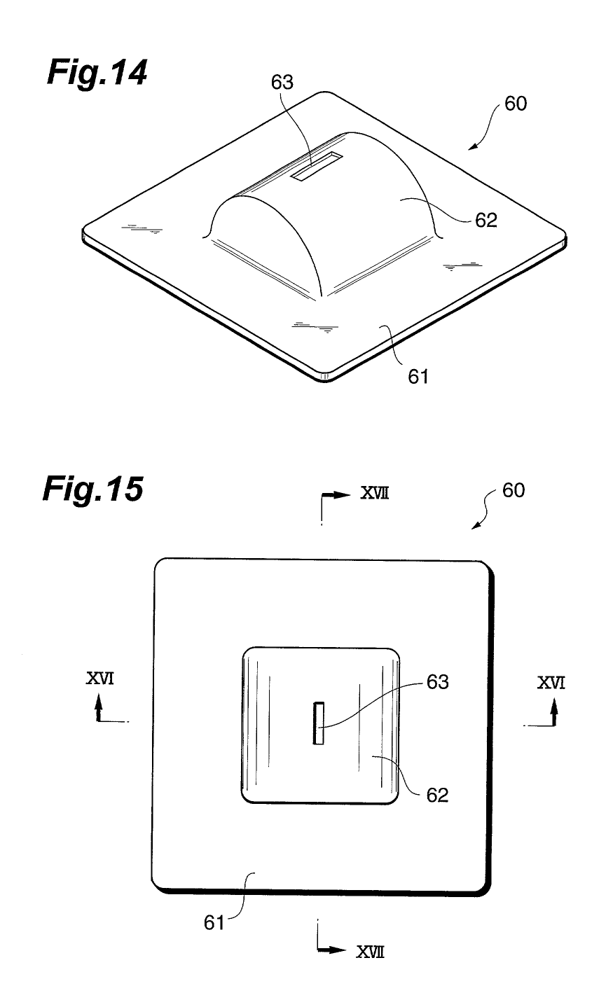

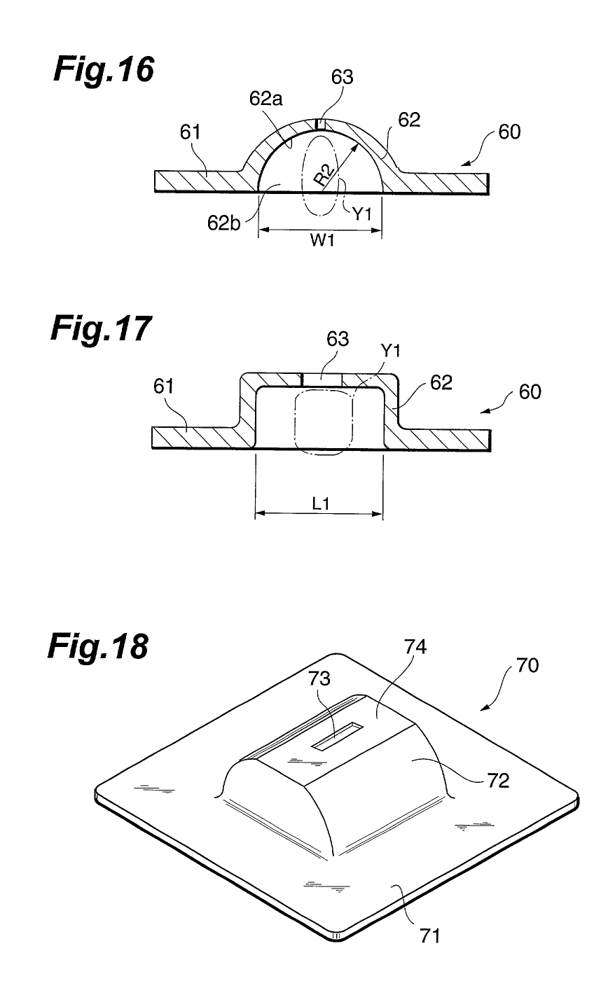

As shown in FIG. 14 to FIG. 17, the opening limiter 60 disposed on the focusing electrode 26 has the rectangular flat substrate 61 of molybdenum, which is the refractory metal. The arc ball receiving recess 62 is made by press work of the substrate 61 and is provided in the center of the opening limiter 60. The arc ball receiving recess 62 is formed in a substantially semicylindrical shape in which the internal surface 62a thereof is formed in an arcuate cross section swelling outward. Specifically, the radius R2 of the internal surface 62a of the arc ball receiving recess 62 is approximately 1.5 mm. The aperture 62b of the recess 62 is formed in a rectangular shape having the width W1 of about 3.0 mm and the length L1 of about 4.0 mm. The focusing opening 63 of the slit shape is formed along the lengthwise direction in the bottom portion of the arc ball receiving recess 62. An oblate arc ball Y1 is generated so as to be received in the arc ball receiving recess 62 of this shape (see the chain line). This oblate arc ball Y1 mostly develops with uniform and high luminance in front of the focusing opening 63, and emits light in the slit form.

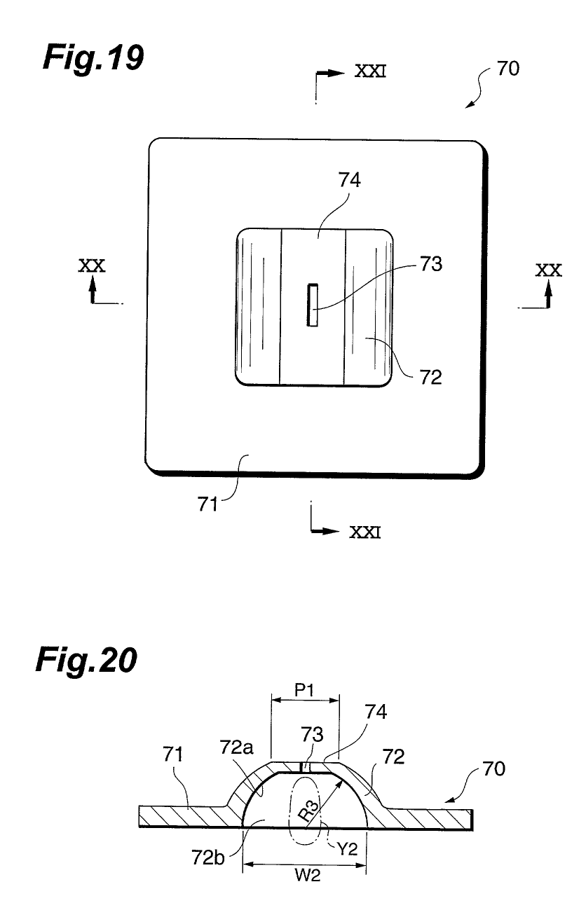

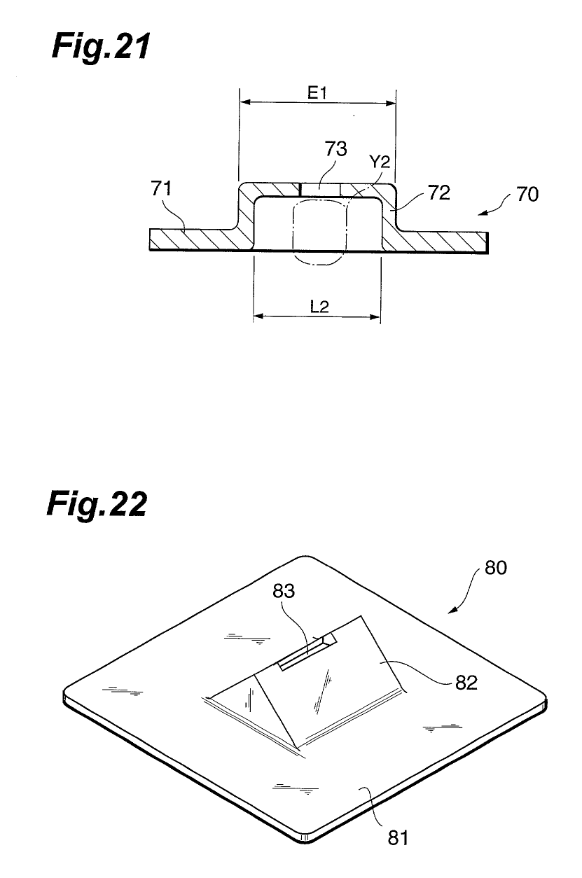

As illustrated in FIG. 18 to FIG. 21, the opening limiter 70 disposed on the focusing electrode 26 has the rectangular flat substrate 71 of molybdenum, which is the refractory metal. The arc ball receiving recess 72 is made by press work of the substrate 71 and is provided in the center of the opening limiter 70. The arc ball receiving recess 72 is formed in a substantially semicylindrical shape in which the internal surface 72a thereof is formed in an arcuate cross section swelling outward. Specifically, the radius R3 of the internal surface 72a of the arc ball receiving recess 72 is approximately 1.5 mm. The aperture 72b of the recess 72 is formed in a rectangular shape having the width W2 of about 3.0 mm and the length L2 of about 4.0 mm. A flat portion 74 is formed in a rectangular shape having the width P1 of 1.0 mm and the length E1 of about 5.0 mm, in the bottom portion of the arc ball receiving recess 72. Then the focusing opening 73 of the slit shape is formed along the lengthwise direction in the center of the flat portion 74. An oblate arc ball Y2 is generated so as to be received in the arc ball receiving recess 72 of this shape (see the chain line). This oblate arc ball Y2 mostly develops with uniform and high luminance in front of the focusing opening 73, and emits light in the slit form.

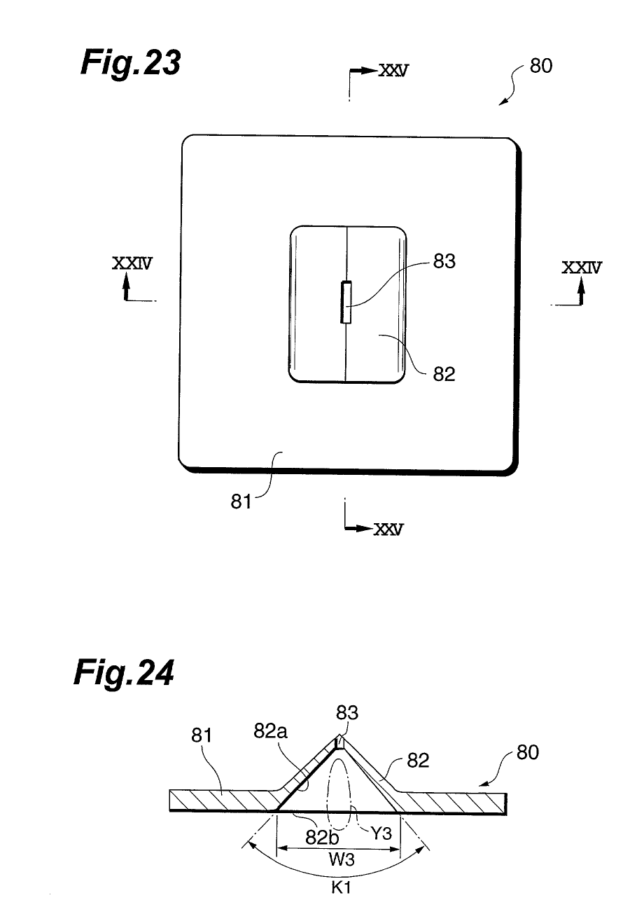

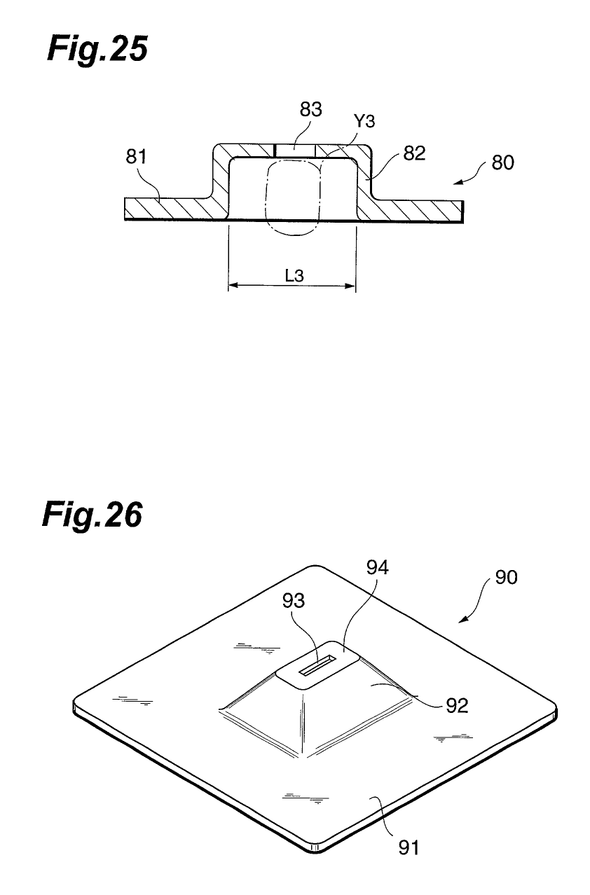

As illustrated in FIG. 22 to FIG. 25, the opening limiter 80 disposed on the focusing electrode 26 has the rectangular flat substrate 81 of molybdenum, which is the refractory metal. The arc ball receiving recess 82 is made by press work of the substrate 81 and is provided in the center of the opening limiter 80. The arc ball receiving recess 82 is formed in a substantially triangular prism shape in which the internal surface 82a thereof is formed in a substantially triangular cross section. Specifically, a divergence angle K1 of the internal surface 82a of the arc ball receiving recess 82 is approximately 90°. The aperture 82b of the recess 82 is formed in a rectangular shape having the width W3 of about 2.0 mm and the length L3 of about 4.0 mm. The focusing opening 83 of the slit shape is formed along the lengthwise direction in the bottom portion of the arc ball receiving recess 82. An oblate arc ball Y3 is generated so as to be received in the arc ball receiving recess 82 of this shape (see the chain line). This oblate arc ball Y3 mostly develops with uniform and high luminance in front of the focusing opening 83, and emits light in the slit form.

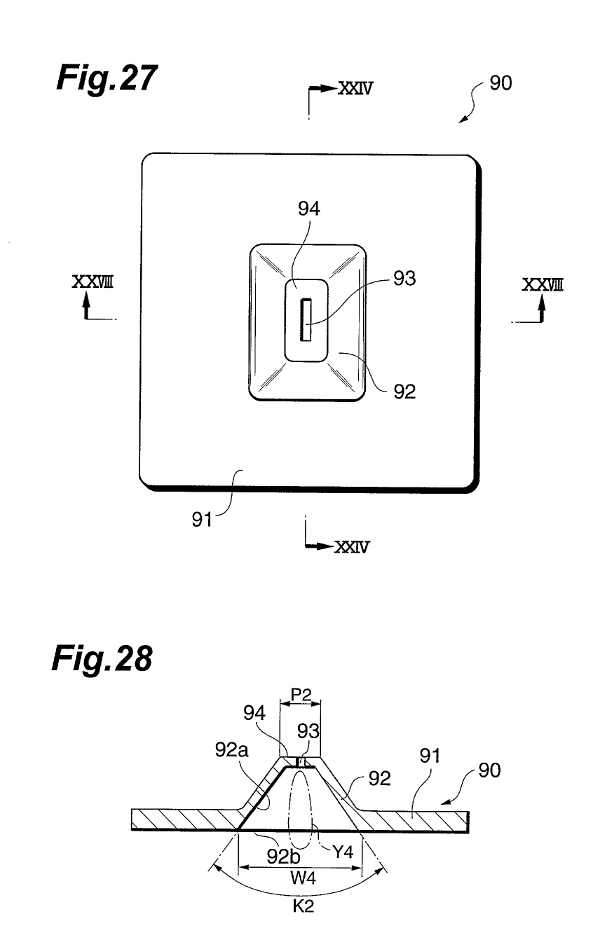

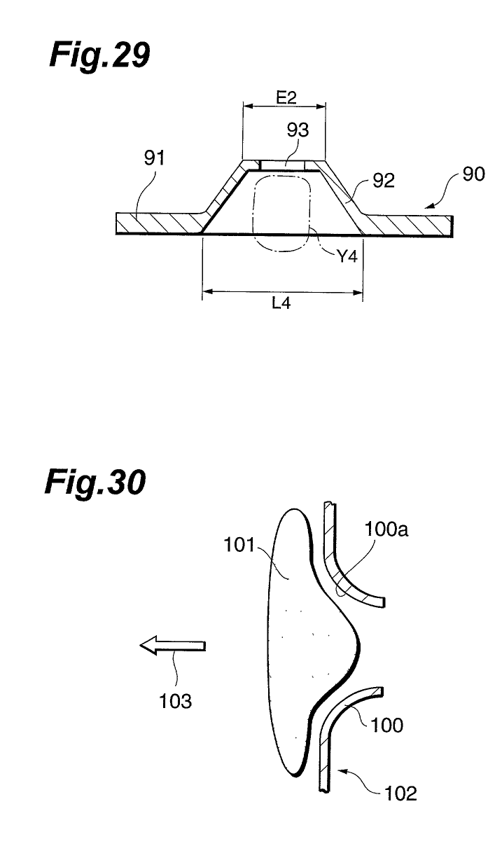

As shown in FIG. 26 to FIG. 29, the opening limiter 90 disposed on the focusing electrode 26 has the rectangular flat substrate 91 of molybdenum, which is the refractory metal. The arc ball receiving recess 92 is made by press work of the substrate 91 and is provided in the center of the opening limiter 90. The arc ball receiving recess 92 is formed in a shape of substantially a frustum of a quadrangular pyramid in which the internal surface 92a thereof is formed in a substantially trapezoid cross section. Specifically, the divergence angle K2 of the internal surface 92a of the arc ball receiving recess 92 is approximately 70°. The aperture 92b of the recess 92 is formed in a rectangular shape having the width W4 of about 3.0 mm and the length L4 of about 4.0 mm. A flat portion 94 is formed in a rectangular shape having the width P2 of about 1.0 mm and the length E2 of about 2.0 mm, in the bottom portion of the arc ball receiving recess 92. The focusing opening 93 of the slit shape is formed along the lengthwise direction in the center of the flat portion 94. An oblate arc ball Y4 is generated so as to be received in the arc ball receiving recess 92 of this shape (see the chain line). This oblate arc ball Y4 mostly develops with uniform and high luminance in front of the focusing opening 93, and emits light in the slit form.

It is a matter of course that the above-described embodiments corresponding to FIGS. 14, 18, 22, and 26 satisfy the aforementioned relation between the opening length A and the opening length B.

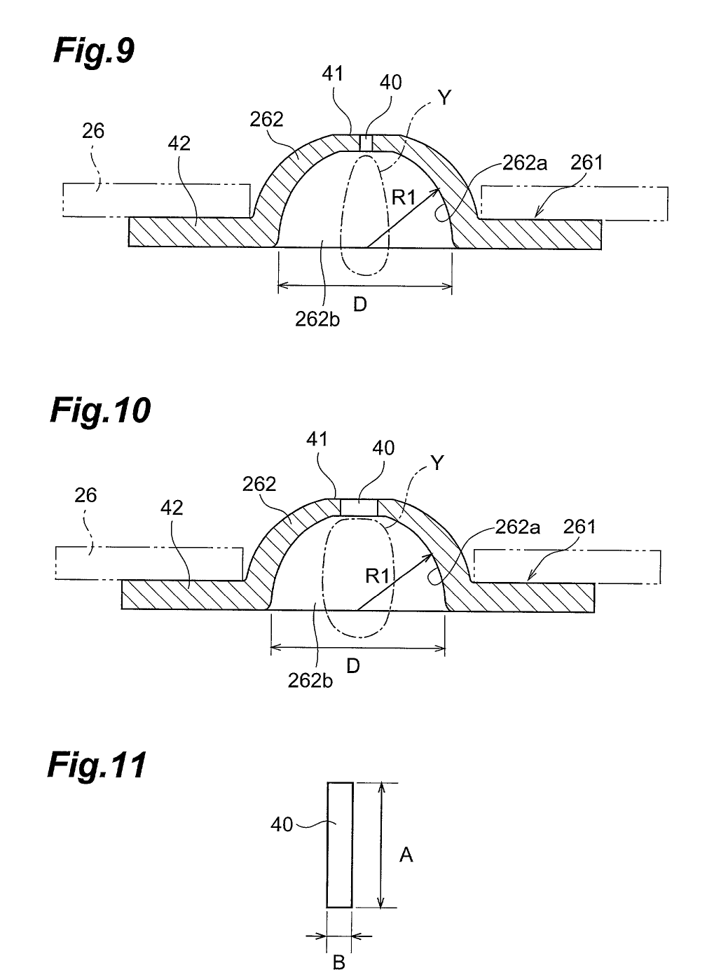

The above embodiments were described as side-on type deuterium lamps, but the present invention can also be applied to head-on type deuterium lamps, for example, like the one described in FIG. 9 and FIG. 10 of U.S. Pat. No. 5,587,625.

With the gas discharge tubes according to the present invention, the arc ball can be formed so as to be received in the arc ball receiving recess in front of the focusing opening of the slit shape. Accordingly, the arc ball can be formed in the well-regulated shape and it becomes feasible to form the arc ball with uniform luminance distribution in the longitudinal direction of the slit focusing opening. As a result, it becomes feasible to obtain a steady emission with high luminance.

From the above description of the present invention, it is apparent that the present invention embraces various modifications. Such modifications are to be considered not to depart from the spirit and scope of the present invention, and all improvements obvious to those skilled in the art should be included in the scope of claims below.

What is claimed is:

1. A gas discharge tube comprising:
a hot cathode for generating thermoelectrons;
an anode for receiving the thermoelectrons; and
a focusing electrode provided between said hot cathode and said anode, for converging said thermoelectrons,
wherein said focusing electrode comprises an arc ball receiving recess projecting toward said anode, an internal surface of the arc ball receiving recess is formed in an arcuate cross section swelling outward, and a focusing opening of a slit shape located in front of said anode is provided in a bottom portion of said arc ball receiving recess.

2. The gas discharge tube according to claim 1, wherein said focusing opening of the slit shape is formed in a flat portion provided in the bottom portion of said arc ball receiving recess.

3. The gas discharge tube according to claim 1, wherein B/A is in a range of 0.1 to 0.5, where A is an opening length in a longitudinal direction of said focusing opening and B an opening length thereof in a direction perpendicular to said longitudinal direction, and wherein an opening area of the focusing opening is in a range of0.15 to 0.5 mm².

4. The gas discharge tube according to claim 3, wherein in said focusing opening, said B/A is in a range of 0.1 to 0.25 and said opening area is in a range of0.15 to 0.25 mm².

5. A gas discharge tube comprising:
a hot cathode for generating thermoelectrons;
an anode for receiving the thermoelectrons; and
a focusing electrode provided between said hot cathode and said anode, for converging said thermoelectrons,
wherein said focusing electrode comprises an arc ball receiving recess projecting toward said anode, an internal surface of the arc ball receiving recess is formed in a substantially triangular cross section, and a focusing opening of a slit shape located in front of said anode is provided in a bottom portion of said arc ball receiving recess.

6. The gas discharge tube according to claim 5, wherein B/A is in a range of 0.1 to 0.5, where A is an opening length in a longitudinal direction of said focusing opening and B an opening length thereof in a direction perpendicular to said longitudinal direction, and wherein an opening area of the focusing opening is in a range of 0.15 to 0.5 mm².

7. The gas discharge tube according to claim 6, wherein in said focusing opening, said B/A is in a range of 0.1 to 0.25 and said opening area is in a range of 0.15 to 0.25 mm².

8. A gas discharge tube comprising:
a hot cathode for generating thermoelectrons;
an anode for receiving the thermoelectrons; and
a focusing electrode provided between said hot cathode and said anode, for converging said thermoelectrons,
wherein said focusing electrode comprises an arc ball receiving recess projecting toward said anode, an internal surface of the arc ball receiving recess is formed in a substantially trapezoid cross section, a flat portion is provided in a bottom portion of said arc ball receiving recess, and a focusing opening of a slit shape located in front of said anode is provided in the flat portion.

9. The gas discharge tube according to claim 8, wherein B/A is in a range of 0.1 to 0.5, where A is an opening length in a longitudinal direction of said focusing opening and B an opening length thereof in a direction perpendicular to said longitudinal direction, and wherein an opening area of the focusing opening is in a range of0.15 to 0.5 mm².

10. The gas discharge tube according to claim 9, wherein in said focusing opening, said B/A is in a range of 0.1 to 0.25 and said opening area is in a range of0.15 to 0.25 mm².
